(19) United States
(12) Patent Application Publication
(10) Pub. No.: US 2024/0274957 A1
(43) Pub. Date: Aug. 15, 2024

(54) MODULAR BATTERY SYSTEM

(71) Applicant: Colibri Energy GmbH, Oberursel (DE)

(72) Inventors: Lorenz Müller, Berlin (DE); Patrick Heine, Berlin (DE)

(21) Appl. No.: 18/568,150

(22) PCT Filed: Jun. 7, 2022
(86) PCT No.: PCT/EP2022/065348

§ 371 Date: Dec. 7, 2023

(30) Foreign Application Priority Data
Jun. 7, 2021 (DE) 20 2021 103 056.9

(51) Int. Cl. H01M 50/258; H01M 10/42; H01M 10/44; H01M 10/48; H01M 10/647; H01M 10/6551; H01M 50/209; H01M 50/264; H02J 7/00

(52) U.S. Cl. CPC H01M 50/258; H01M 10/425; H01M 10/441; H01M 10/482; H01M 10/647; H01M 10/6551; H01M 50/209; H01M 50/264; H02J 7/0013; H02J 7/0045; H01M 2010/4271; H01M 2010/4278

(57) ABSTRACT

A modular battery system includes a plurality of electrical storage cell modules having a cell housing and an adapter connection, and a modular unit having a base housing containing a battery management system for monitoring and controlling the charging and discharging of the plurality of electrical storage cell modules. A plurality of adapter connection points for reversibly receiving the adapter connections are adapted to the shape of the adapter connections. The adapter connection points and adapter connections have electrical contacts that correspond to one another. At least one interface is arranged on the base housing for electrically connecting the modular unit to a consumer and/or supplier system. Power electronics arranged in the base housing transmit electrical energy between the interface and the storage cell modules. The base housing has at least one opening for removing and/or introducing the plurality of storage cell modules in relation to the adapter connection points.

### BACKGROUND

### Technical Field

The present disclosure relates to a modular battery system.

Battery systems can be used, for example, as drive battery systems for the energy supply of electric vehicles. Battery systems can also be used as electricity storage in a local or supra-regional supply network.

### Description of the Related Art

Battery systems consist of at least one electrochemical battery cell and battery management and power electronics. The electrochemical battery cell is composed of a group of electrodes in an electrolyte material within an electrolyte container with electrical contacts on the outer side thereof. In a battery system, a plurality of battery cells are often connected in series or in parallel in order to provide a desired capacity and power output.

One of the greatest barriers which the electrification of the mobility sector (industrial, heavy-duty, municipal, private, on-road and off-road) has to overcome consists in the economic equivalence with existing fuels and drive technologies. In this case, a great challenge lies in the costs of the battery system, which account for a large proportion of the total costs of, for example, electric vehicles.

In the course of the energy transition, a great challenge lies in the consumption-adapted provision of electrical energy by the electricity supply grid. This is because the provision of electrical energy from renewable energy sources, such as wind power installations or photovoltaic installations, is to a considerable extent dependent on weather and, unlike electrical energy from power stations which consume fossil fuels for the purpose of generating electricity, cannot be adapted to an actual electricity consumption in the electricity supply grid. Energy storages, such as battery systems, are therefore necessary in order to absorb excess energy in the case of favorable weather and to output it again only at a later point in time if required. The enormous costs of large energy storage installations on the basis of battery systems constitute an obstacle to investment and therefore an obstacle to development.

U.S. Pat. No. 10,008,869 B2 describes a battery system which is intended to allow mobile and flexible adaptability for use in a scalable supply grid. The battery system has a cylindrical casing with mutually opposite contact units. Functional groups composed of a plurality of energy storage cells are provided within the cylindrical casing, said energy storage cells being separated from one another in a short-circuit-proof manner by insulations and being fastened with holders. Furthermore, a communication interface, on the one hand, and a control apparatus, on the other hand, are accommodated in the cylindrical casing at the opposite contact units. A multiplicity of battery systems can be combined in blocks in order, for example, to provide a large capacity as energy storage for wind power installations. A standardizable system is intended to be realized by the use of a plurality of similar battery systems.

In addition to the general reduction of production costs by scaling effects, it is additionally necessary to consider and to optimize the actual costs over the product service life. Above all, the actual battery cells are subject to a consumption-related capacity reduction and other signs of aging over the course of the service life of a battery. In contrast to this, the remaining system components are often adapted or can be adapted for a significantly longer life cycle without generating an economic disadvantage in comparison with a shorter-lived solution. Furthermore, it should be noted that in some cases high innovation potential and also cost reduction potentials are to be located in the region of the actual battery cell. At the same time, there is the problem for battery integrators that the cell price can be influenced only slightly on account of the high demand and the high dependence on battery cell manufacturers.

A further cost saving potential however exists in the case of the other battery system components beyond the electrochemical battery cell. Consequently, there is a desire to reduce the high price of modern battery systems by the amount of the other battery system components. The possibility for this is seen inter alia in the continued use or reuse of the battery system components which are not subject to the same wear and tear as the actual battery cell. One aim here lies in a reuse of a battery system in the same application. Thus, for example, vehicles with a significantly increased service life could be used, since the drive battery is often the first part which is worn. Alternatively, it may be desirable to continue to use a battery system in an application with lower requirements (“second life”). Since conventional battery systems are in many cases highly adapted to a specific application, high integration costs are often incurred for adaptation during the continued use of battery systems in another application, which makes a continued use sometimes appear economically unattractive.

Both during the continued use and the reuse, the mechanical separation of battery system components and battery cells has been found to be a problem. Especially, in the field of electromobility, battery cells and battery system components are often configured as an inseparable unit, with the result that the separation can be effected only with high expenditure and risk of damage. In addition, there is often a high risk of injury and damage owing to uninsulated electrical connections between battery cells and battery system components.

Thus, there is accordingly a need to provide a battery system which overcomes the disadvantages of the prior art and in some cases ensures improved continued usability and reusability, in some other cases with simplified and safe handling.

### BRIEF SUMMARY

Accordingly, a modular battery system has been found, comprising:
a plurality of, in some cases identically shaped, electrical storage cell modules having a cell housing and an adapter connection arranged on a base side of the cell housing, and an assembly having a base housing, containing
   a battery management system arranged in the base housing, arranged and adapted for monitoring and controlling charging and discharging of the plurality of electrical storage cell modules, wherein in some cases the battery management system comprises measuring, monitoring and/or protective electronics;
   a plurality of adapter connections sites for reversibly receiving the adapter connections, wherein the adapter connections sites are form-fitted to the adapter connections and wherein the adapter connections sites and adapter connections have mutually corresponding electrical contacts,
   at least one interface arranged on the base housing for electrically connecting the assembly to a consumer and/or supply system, in some cases for voltages in the range of 24 VDC to 150 VDC,
   power electronics arranged in the base housing for transmitting electrical energy between the interface and the storage cell modules.

Further, a modular battery system has been found, comprising:
a plurality of, in some cases identically shaped, electrical storage cell modules having a cell housing and an adapter connection arranged on a base side of the cell housing, and an assembly having a base housing, containing
   a battery management system arranged in the base housing, arranged and adapted for monitoring and controlling charging and discharging of the plurality of electrical storage cell modules, wherein in some cases d the battery management system comprises measuring, monitoring and/or protective electronics;
   a plurality of adapter connections sites for reversibly receiving the adapter connections, wherein the adapter connections sites are form-fitted to the adapter connections and wherein the adapter connections sites and adapter connections have mutually corresponding electrical contacts,
   at least one interface arranged on the base housing for electrically connecting the assembly to a consumer and/or supply system, in some cases for voltages in the range of 24 VDC to 150 VDC,
   power electronics arranged in the base housing for transmitting electrical energy between the interface and the storage cell modules, wherein the base housing has at least one opening for removing and/or inserting the plurality of storage cell modules opposite the adapter connections sites.

Thus, according to the present disclosure, a modular battery system is provided which comprises a plurality of electrical storage cell modules and an assembly with a base housing which contains a battery management system, a plurality of adapter connections sites, at least one interface and power electronics.

### BRIEF DESCRIPTION OF THE SEVERAL VIEWS OF THE DRAWINGS

Further features and advantages of the present disclosure result from the following description, in which exemplary embodiments of the present disclosure are explained by way of example with reference to schematic drawings, without thereby restricting the present disclosure. In the drawings:

FIG. 1 shows a perspective illustration of a modular battery system according to the present disclosure;

FIG. 2 shows a schematic illustration of an assembly for a modular battery system according to the present disclosure;

FIG. 3 shows a schematic illustration of an electrical storage cell module for a modular battery system according to the present disclosure;

FIG. 4 shows an exemplary connection plate for a modular battery system according to the present disclosure;

FIG. 5 shows a perspective illustration of the assembly from FIG. 1;

FIG. 6 shows a perspective illustration of an assembly similar to FIG. 5 with a vertical support structure;

FIG. 7 shows a battery system with an assembly according to FIG. 6;

FIG. 8 shows a perspective illustration of another assembly;

FIG. 9 shows a perspective illustration of an assembly similar to FIG. 8 with a horizontal support structure; and

FIG. 10 shows a battery system with an assembly according to FIG. 9.

### DETAILED DESCRIPTION

The plurality of electrical storage cell modules of a battery system can be a number in the range of 6 to 1,000, in some cases in the range of 20 to 100. The storage cell modules each have an individual cell housing and an adapter connection. A storage cell module can comprise exactly one or more storage cells. The respective adapter connection is arranged on a base side of the respective cell housing. It can be expedient that the flank side(s) of the cell housing and/or the end face of the cell housing are free of connection interfaces such as, for example, data transfer connections, electrical contacts and/or hydraulic connections. The cell housing of an individual storage cell can have a dust-tight and/or water-tight cell housing casing, in some cases a cell housing casing of at least the protection class IP20, IP55, IP6K9K or denser. The plurality of electrical storage cell modules can be formed in some cases identically shaped. The shape of a storage cell module is in some cases generally cylindrical, in some other cases with a circular cross section, or prismatic, with a polygonal, in some cases rectangular, for example square, cross section. The cross section of the storage cell module can have at least one asymmetrical section, for example a flattening, a projection and/or a recess, which is adapted and arranged to define a unique insert orientation of the cell housing.

The base housing and the cell housings differ from one another. The base housing is part of the assembly. Each of the plurality of electrical storage cell modules has an individual cell housing, or in other words each storage cell module is assigned its own cell housing. The cell housings of different storage cell modules can be structurally identical. The base housing and the cell housings can be form-fitted to one another. The plurality of cell housings can be reversibly fastened to the base housing. For example, a screw connection can be provided for fastening in each case one or in each case a plurality of cell housings to the base housing. It can be expedient that the cell housings have no direct connection to one another. The housings are in some cases connected to one another by means of the base housing. The base housing can have a dust-tight and/or water-tight base housing casing, in some cases a base housing casing of at least the protection class IP20, IP55, IP6K9K or denser.

The battery management system is arranged in the base housing. The battery management system is arranged and adapted for monitoring and controlling charging and discharging of the plurality of electrical storage cell modules. In some cases, the battery management system comprises measuring electronics, monitoring electronics and/or protective electronics. It can be expedient that the battery management system (BMS) is adapted and arranged to monitor and/or control the total voltage of the battery system. Alternatively or additionally, the battery management system can be adapted and arranged to monitor and/or control the voltage of individual storage cell modules and/or individual storage cells accommodated within storage cell modules. In some cases, the battery management system is adapted and arranged to monitor and/or control an input current flow and/or an output current flow of the battery system, individual storage cell modules and/or individual storage cells. The battery management system can further be adapted and arranged for temperature monitoring of the battery system, individual storage cell modules and/or individual storage cells. The protective electronics can be arranged and adapted to prevent exceeding and/or falling below predetermined threshold values with respect to voltage and/or current flow. The measuring electronics can be arranged and adapted to determine an actual value, for example with respect to a voltage, a current flow or a temperature.

The assembly has a plurality of adapter connections sites for reversibly receiving the adapter connections of the plurality of storage cell modules. The plurality of adapter connections sites of a battery system can be a number in the range of 10 to 1,000, in some cases in the range of 20 to 100. In some cases, the adapter connections sites of the assembly are identically shaped. In some cases, the number of adapter connections sites can correspond to the number of storage cell modules. The adapter connections sites are form-fitted to the adapter connections of the storage cell modules, in some cases shaped to be complementary to one another. In some cases, the adapter connections sites are fitted to the adapter connections such that a direction of insertion of a storage cell module into an associated adapter connections site is uniquely defined. Additionally or alternatively, the adapter connections sites are fitted to the adapter connections such that a position of insertion of a respective storage cell module relative to the assembly is defined. The adapter connections sites and the adapter connections have mutually corresponding electrical contacts. The electrical contacts of the adapter connections and the adapter connections sites permit the transmission of an electrical voltage and/or an electrical current between a respective storage cell module and the assembly. In some cases, the electrical contacts of the respective adapter connection of a storage cell module are arranged in a concave recess and/or in a recess offset in the direction of the cell housing interior. The electrical contacts of a respective adapter connection can be socket-like, such that an inadvertent touch contact by a user is prevented. The adapter connections sites can be plug-like, wherein protective electronics of the assembly can be adapted and arranged to avoid short circuits at the adapter connections sites. In some cases, the electrical contacts of a respective adapter connections site can be arranged at or as a concave projection and/or a projection projecting in the direction of the base housing interior. In some cases, the plurality of adapter connections sites are arranged stationary on the assembly, in some other cases stationary on the base housing.

The assembly has at least one interface arranged on the base housing for electrically connecting the assembly to a consumer and/or supply system. The interface arranged in the base housing comprises in some cases a power transmission line and a data transmission line, in some other cases separated from the power transmission line. The consumer system can be, for example, a drive system of an electric vehicle, to which the battery system serves as a drive battery system. The supply system can be, for example, a recuperation system or a charging point connection of an electric vehicle, which supplies the battery system with electrical energy. It can be expedient that the interface is adapted for voltages of at least 24 VDC, in some cases at least 28 VDC, in some other cases at least 60 VDC, and/or for voltages of not more than 300 VDC, in some cases not more than 150 VDC, in some other cases not more than 120 VDC. An operating voltage of at least 60 VDC is generally required in the logistics sector. For many applications, the low-voltage range up to a maximum of 150 VDC has proven to be practical.

A power electronics is arranged in the base housing, which is adapted and arranged to transmit electrical energy between the interface and the storage cell modules. On the one hand, electrical energy can be fed from the interface into a storage cell module or a plurality of storage cell modules in order to charge the latter. Conversely, electrical energy can be provided from a storage cell module or from a plurality of storage cell modules through the interface to a consumer system. For transmitting electrical energy between the power electronics and a respective storage cell module, the electrical contacts of the adapter connections and adapter connections sites associated therewith are provided.

The base housing is arranged opposite the storage cell modules relative to the adapter connections sites. In some cases, the adapter connections sites are arranged on the base housing such that insertion and/or removal of the storage cell modules from the adapter connections sites is unhindered by the base housing. For example, in the position of insertion of the storage cell modules, the adapter connections sites are arranged between the storage cell modules and the base housing. In some cases, the base housing is shaped such that unhindered removal and/or unhindered insertion of the plurality of storage cell modules in a direction of insertion is ensured. With respect to the base housing, the direction of insertion of the plurality of storage cell modules can be aligned in parallel to one another. It is conceivable for the base housing to extend in areas adjacent to the adapter connections sites at least in sections in parallel to the direction of insertion of the storage cell modules on the storage cell side of the adapter connections sites. It can be expedient that, with respect to the adapter connections sites, the base housing is arranged exclusively on a first side of the adapter connections sites and the storage cell modules are arranged exclusively on the other side of the adapter connections sites. The base housing can have at least one opening for removing and/or inserting the plurality of storage cell modules opposite the adapter connections sites.

In contrast to conventional battery systems in which a base housing surrounds both battery cell modules and battery management and power electronics, the configuration according to the present disclosure enables in some cases a simple handling and in some cases separation of the battery cell modules from other battery system components. In the battery system according to the present disclosure, defective storage cell modules and storage cell modules which have reached the end of their service life can be removed in a simple manner and without risk of injury or damage. In this case, the assembly of the modular battery system can remain in the area of the application and only be equipped with fresh storage cell modules for reuse of the battery system. Furthermore, battery systems according to the present disclosure can be compatibly equipped in different applications such that the integration adaptation with respect to the respective application is ensured by the specific assembly, whereas the storage cell modules can be designed to be interoperable, i.e., can be associated with the one or the other application as desired without modification requirement. In some cases large scaling effects can be achieved by the use of the same or similar storage cell modules in a wide variety of applications.

According to one embodiment, the base housing has a connection surface on at least one or exactly one outer side, on which the plurality of adapter connections sites in some cases all are arranged. Such a connection surface can be referred to as a backplane. The backplane can comprise in each case one or more screw connections per adapter connections site for fastening the storage cell module or the storage cell modules. It can be expedient that a single connection surface is provided on the base housing. The connection surface can extend over the entire surface on an outer side of the base housing. An outer side of the base housing can be formed partially or completely by the connection surface. In some cases, all adapter connections sites of the battery system are arranged in the connection surface in one plane, in some cases in a checkerboard pattern. In some cases a simple maintainability of the battery system is achieved by the provision of a backplane.

In one development, the connection surface and the adapter connections have mutually corresponding heat transfer means. The heat transfer means are arranged and adapted for dissipating thermal energy from the storage cell modules to the assembly and/or for introducing thermal energy from the assembly into the storage cell modules. The heat transfer means can comprise heat conducting contacts which are adapted and arranged for conductive heat transport from the storage cell module into the assembly or vice versa. Additionally or alternatively, the heat transfer means can comprise hydraulic connections which are arranged and adapted for convective heat transport from or into a respective storage cell module. Since the heat transfer means are integrated into the adapter connections for energy-efficient temperature management of the battery system, no particular handling effort is necessary when introducing or separating individual storage cell modules.

According to another development, which can be combined with the previous development, the base housing has an L-shaped basic shape. An L-shaped base housing has two legs projecting transversely, in some cases orthogonally, to one another, which legs define leg inner sides facing toward one another and leg outer sides facing away from one another. The legs meet one another at an abutment edge and have mutually opposite leg ends remote from the abutment edge. Both the leg inner sides and the leg outer sides form outer sides of the base housing. The connection surface extends on one of the two leg inner sides. The interface is arranged on a leg, in some cases on the leg end. It can be expedient that the connection interfaces have a direction of insertion transversely, in some cases perpendicularly, to the inner side associated with the connection surface, wherein in some cases the interface is arranged on the leg end projecting in the direction of insertion. Alternatively, the interface can be arranged transversely to the direction of insertion of the storage cell modules on a side surface of the leg. In some cases, the connection surface is arranged on a first leg and the interface is arranged on a second leg different from the first. In some cases, an L-shaped shape of the base housing allows simple access both to the storage cell modules and to the interface, such that simple installation and removal of the battery system, the system components thereof, and storage cell modules is ensured.

In one embodiment of the modular battery system, the power electronics are arranged and adapted to connect the electrical contacts of the adapter connections sites to one another, in some cases in series and/or in parallel, such that the storage cell modules received by the adapter connections sites form a battery.

In another embodiment of a modular battery system, which can be combined with the previous embodiments, the, in some cases identically shaped, adapter connections sites each have at least one electrical main connector, in some cases in the form of a plug-in, clamping or blade-plug connector, and in some further cases an auxiliary connector. In some cases, the main connector and in some further cases the auxiliary connector protrude from the base housing, in some cases in a plug-like manner. In some cases, electrical contacts in the form of in each case at least one projecting main connector are provided at the adapter connections sites and main connector receptacles corresponding thereto, in some cases shape-complementary, with internal electrical contacts are provided at the adapter connections. The use of main connectors allows safe and error-free contacting to be realized in a simple manner.

In one embodiment of the modular battery system, the adapter connections sites have at least one mechanical and/or electronic reverse polarity protection which corresponds, in some cases shape-complementary, to a reverse polarity protection of at least one adapter connection of the electrical storage cell or of the storage module. The reverse polarity protection is in some cases adapted and arranged to ensure that electrical contacts of the storage cell modules and of the adapter connections sites cannot be connected to one another in the wrong polarity. The mechanical reverse polarity protection can be provided in addition to or in functional union with an, in some cases asymmetrical, section of the cell housing, of the adapter connection and/or a section, in some cases corresponding thereto, of an adapter connections site which is adapted and arranged to define a distinct insert orientation of the cell housing with respect to the associated adapter connections site. In this way, simple and safe handling is ensured.

According to a further embodiment of the modular battery system, the adapter connections sites each have a contact protection, arranged and adapted to ensure a correct connection of the electrical contacts, in some cases comprising at least one microswitch, induction sensor, near-field radio transmitter and/or receiver, light barrier, and/or temperature sensor. In some cases, the contact protection is adapted and arranged to allow an electrical connection between a storage cell module and the associated adapter connections site only when this storage cell module is in a predetermined insert position in which the electrical contacts between adapter connection and adapter connections site form a well-defined touch contact for, in some cases arc-free, transmission of electrical energy. The contact protection ensures that even an inexperienced assembler can easily and safely connect storage cell modules to the assembly or separate them from it without the risk of an accident.

In one embodiment, a modular battery system further comprises at least one telemetry unit, at least one communication device, and/or at least one power distribution device. The telemetry unit, communication device, and/or power distribution device can be a component of the assembly and is arranged in some cases within the base housing. The integration of different electronic units in the assembly and in some cases the base housing allows the same or the same unit to be used for a plurality of electronic storage cell modules, such that redundant units in each individual storage cell module can be omitted, which is associated with considerable savings.

In one embodiment, which can be combined with the previous embodiments, it is provided that an electrical storage cell module comprises a plurality of, in some cases stacked, electrical storage cells arranged within the respective cell housing. The storage cells of the storage cell module can be connected in series and/or in parallel to a battery module. Alternatively, a single storage cell can be accommodated in the cell housing. In a modular battery system, according to a further embodiment, which can be combined with the previous embodiments, the electrical storage cell modules can be based on lithium-ion technology or solid-state battery technology. Alternatively, the storage cell or the storage cells of the storage cell module can be based on another, in some cases a previously unknown, electrolyte technology. At present, a high innovation potential and also a high saving potential caused by production capacity growth is expected in the field of electrochemical storage cell technology, which can be exploited with the aid of the modular battery system according to the present disclosure.

According to an expedient embodiment, it is provided that the plurality of electrical storage cell modules is free of individual measuring electronics, monitoring electronics and/or (in some cases and) protective electronics, in some cases arranged in or on the cell housing. In some cases, plurality of electrical storage cell modules is free of a respective storage cell module-individual battery management system, in some cases arranged on or in the cell housing. Additionally or alternatively, it can be provided that the plurality of electrical storage cell modules is free of a storage cell module-individual power electronics, in some cases arranged on or in the cell housing. It can be expedient that the power electronics and/or the battery management electronics are accommodated in the assembly outside the individual storage cell modules, in some cases remote from the respective cell housing, in some other cases exclusively, in some even other cases within the base housing. With such a modular battery system, it can be ensured that substantially only the storage cell(s) together with a smallest possible quantity of further electronic components, such as connecting lines and electrical contacts of the respective adapter connection, are accommodated within the respective cell housing. Any other electronic battery system components are provided in the assembly, separately from the storage cell modules, such that separate handling, on the one hand, of the actual storage cell(s) and, on the other hand, of the other battery system components for the respective continued use or reuse thereof is possible in a simple manner.

A further embodiment of a modular battery system comprises at least one insulation monitoring unit. The insulation monitoring unit improves the simple and safe handling of the battery system.

According to an expedient embodiment of the modular battery system, the battery management system is adapted and arranged to monitor the state of charge, the state of health and the functional state of the plurality of electrical storage cell modules, in some cases the respective storage cells thereof.

In one embodiment of a modular battery system, the assembly has a support structure which comprises receptacles for a plurality of storage cell modules. In some cases, the number of receptacles corresponds to the number of adapter connections sites of the assembly. In some cases, the receptacles are shaped to be complementary in shape to the cell housings. Alternatively or additionally, the receptacles form the removal opening through which the storage cell modules can be removed from the assembly and the base housing. It can be expedient that the support structure extends starting from the base housing, in some cases a connection surface, transversely to the base housing and/or the connection surface, in some other cases in the direction of insertion of the storage cell modules. The extension height of the support structure substantially corresponds to the length of a storage cell module in the direction of insertion. In some cases, the extension height of the support structure corresponds to at least one third, in some other cases at least half, in some even other cases at least three quarters of the length of a storage cell module. It is clear that the in some cases identically shaped storage cell modules can experimentally have the same length. With the aid of the support structure, guides can be realized which ensure tilting-free insertion of the storage cell modules into the respectively corresponding adapter connections sites. The support structure can realize at least one heat transfer means and/or at least one heat exchanger, in some cases an air heat exchanger, on the part of the base housing. The support structure can alternatively or additionally provide a casing for the storage cell modules for the protection thereof against mechanical, in some cases static and/or pulse-like, loading.

In a modular battery system according to another embodiment, the adapter connections sites and the respectively corresponding adapter connections are reversibly releasably connected or connectable to one another via a latching connection. With the aid of a latching connection, the predetermined insertion position can be reliably reproducibly set.

According to one embodiment, the modular battery system comprises at least one heat exchanger. The at least one heat exchanger can be arranged on the base housing of the assembly. Alternatively or additionally, the cell housing of the plurality of storage cell modules can be equipped with a respective heat exchanger. The at least one heat exchanger of the battery system can be configured as an air heat exchanger.

According to one embodiment of the modular battery system, the assembly comprises at least one cooling aggregate and/or heating aggregate, in some cases accommodated in the base housing. The cooling aggregate and/or heating aggregate is in some cases connected according to heat transfer to the adapter connections sites in order to supply heat to the storage cell modules or to remove heat from the storage cell modules, in some cases with the aid of heat transfer means.

In the modular battery system, according to another embodiment, which can be combined with the previous embodiments, it is provided that the cell housing is a plastic housing. A plastic housing allows simple handling of the storage cell modules without a risk of electric shock.

The present disclosure also relates to the use of a previously described modular battery system or a plurality of previously described modular battery systems in an electric vehicle. Alternatively, the present disclosure can also relate to the use of a previously described modular battery system or a plurality of previously described modular battery systems in an electricity storage of a local or supra-regional supply grid.

Expedient embodiments of the present disclosure are described in the appended claims.

In the following description of expedient embodiments of the present disclosure, the same or similar reference signs are used to simplify readability for the same or similar components.

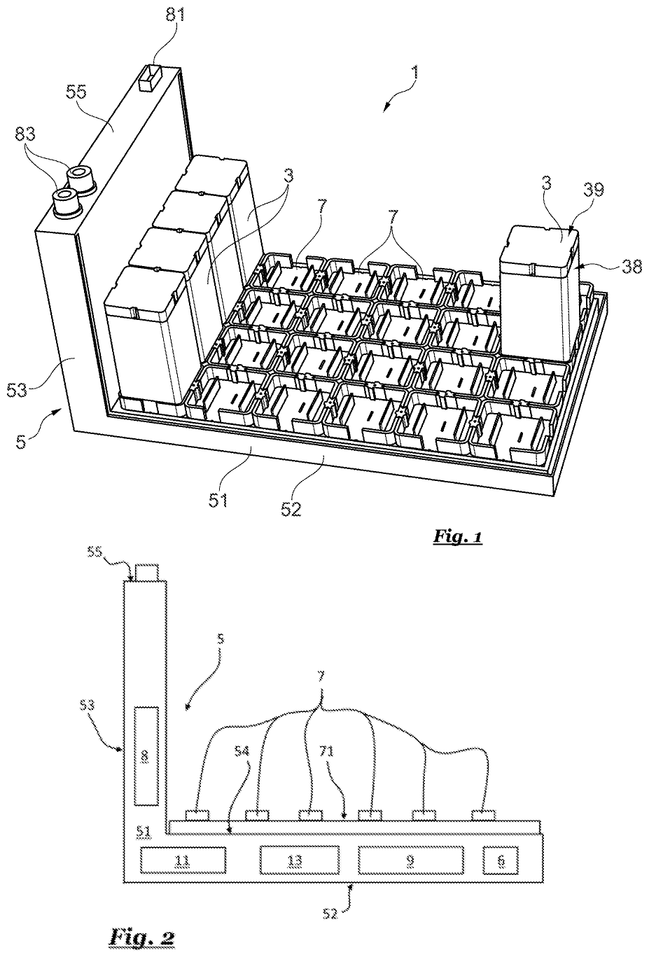

FIG. 1 shows a battery system according to the present disclosure, which is generally provided with the reference sign 1 below. The modular battery system 1 comprises a plurality of storage cell modules 3 and an assembly 5 as the main constituent part. The assembly 5 is described in detail below with reference to FIG. 2.

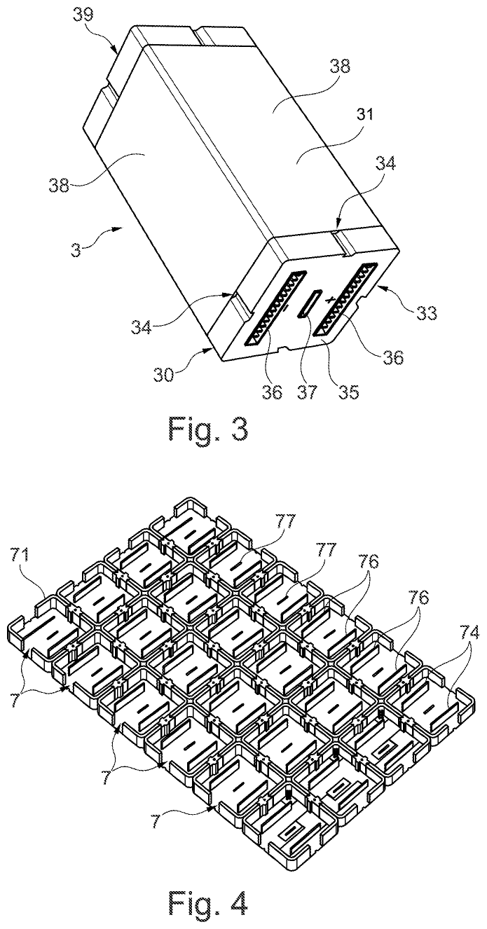

The storage cell modules 3 are identically shaped and have similar adapter connections 35 at the base end 33 of their respective cell housing 31 and are thereby interchangeable as desired. An exemplary storage cell module 3 is described in detail below with reference to FIG. 3.

FIG. 2 shows the assembly 5, which comprises a base housing 51. The assembly 5 comprises a battery management system 6, a plurality of adapter connections sites 7, at least one interface 8 and power electronics 9. The base housing 51 surrounds the battery management system 6 and the adapter connections sites 7. The adapter connections sites 7 are arranged on an outer side of the base housing 51. The adapter connections sites 7 can be realized by a connection plate 71. The connection plate 71 can also be referred to as a backplane and is described in detail below with reference to FIG. 4. The at least one interface 8 is likewise arranged on an outer side of the base housing 51.

The battery system 1 depicted in FIG. 1 has 24 identically shaped adapter connections sites 7 arranged in the manner of a checkerboard pattern in four columns and six rows, which are respectively adapted and arranged to receive an individual storage cell module 3 in a form-complementary manner. For better readability, only five such storage cell modules 3 are depicted in FIG. 1. Storage cell modules 3 can be inserted into the adapter connections sites 7 in a direction of insertion or can be removed from a respective adapter connections site 7 in the direction of insertion. With respect to the direction of insertion, the storage cell modules 3 are arranged opposite the base housing 51 in relation to the adapter connections sites 7. The base housing 51 or the assembly 5 does not impede the insertion and/or removal of the storage cell modules 3 from the adapter connections sites 7.

The base housing 51 is L-shaped. The base housing 51 is composed of two legs 52, 53 perpendicular to one another. The first leg 52 extends transversely to the direction of insertion and the second leg 53 extends in parallel to the direction of insertion. The adapter connections sites 7 are arranged in the form of a connection plate 71 on a leg inner side 54 of the first leg 52. The at least one interface 8 is arranged in or on the second leg 53. In the present example, the interface 8 is composed of a data transmission line 81 and two power transmission lines 83. Both the data transmission line 81 and the power transmission lines 83 are arranged on the end 55 of the second leg 53 projecting in the direction of insertion.

FIG. 2 shows a schematic side view of the assembly 5. Also in the assembly 5 illustrated in FIG. 2, the base housing 51 is L-shaped, corresponding to that previously described with respect to FIG. 1. Both the power electronics 9 and the battery management system 6 are accommodated in the interior of the base housing 51. Furthermore, a communication device 11 is accommodated in the interior of the base housing 51. In addition, further devices 13, such as, for example, auxiliary systems, at least one monitoring electronics, at least one measuring electronics, and/or at least one protective electronics, are arranged in the interior of the base housing 51. Additionally or alternatively, the further devices 13 can comprise a telemetry unit and/or a power distribution device.

The connection plate 71 extends substantially over the entire surface over the inner outer side 54 of the base housing 51. Adapter connections sites 7 with mechanical and electrical connectors for connecting the plurality of adapter connections 35 corresponding to the adapter connections sites 7 are provided on the side of the connection plate 71 opposite the base housing 51.

FIG. 3 shows an exemplary embodiment of a storage cell module 3. The storage cell module 3 has a prismatic shape. An electrical storage cell or a plurality of electrical storage cells (not illustrated in more detail) are accommodated in the interior of the cell housing 31. The cell housing 31 has a base side 33 on which the adapter connection 35 is provided. Opposite the base side 33, the cell housing 31 has an end face 39. Mutually parallel flank sides 38 extend between the base side 33 and the end face 39. The flank sides 38 form a square cross-sectional shape of the exemplary storage cell module 3 depicted here.

FIG. 4 shows a connection plate 71 which consists of a plurality of identically shaped adapter connections sites 7. Each adapter connections site 7 is arranged with two main connectors 76 protruding in insertion directions. An auxiliary connector 77 protrudes between the main connectors 76. The adapter connection 35 has two electrical main connector receptacles 36 and an auxiliary connector receptacle 37. Electrical contacts which are adapted and arranged to be brought into contact with corresponding electrical contacts of the main connectors in order to transfer electrical energy between storage cells, on the one hand, and the assembly 5, on the other hand, are accommodated in the main connector receptacles 36. It is conceivable for a contact protection to be realized in the auxiliary connector receptacle 37 together with the auxiliary connector 77, which contact protection is adapted and arranged to ensure a correct electrical connection of the electrical contacts in the position of insertion. Alternatively or additionally, matched auxiliary connectors 77 and auxiliary connector receptacle 37 can form a heat transfer means in order to remove heat from the storage cell modules 3 or to supply heat to them.

Differently shaped recesses 34 which bring about an asymmetrical shape of the adapter connection 35 in sections are arranged along the circumference 30 of the adapter connection 35. The recesses 34 on the adapter connection 35 correspond to complementary projections 74 of the adapter connections sites 7. A pairing of corresponding recesses 34 and projections 74 realizes a mechanical reverse polarity protection. A form-corresponding shape of the adapter connections sites 7 and of the storage cell modules 3 brings about a distinctly defined insert orientation.

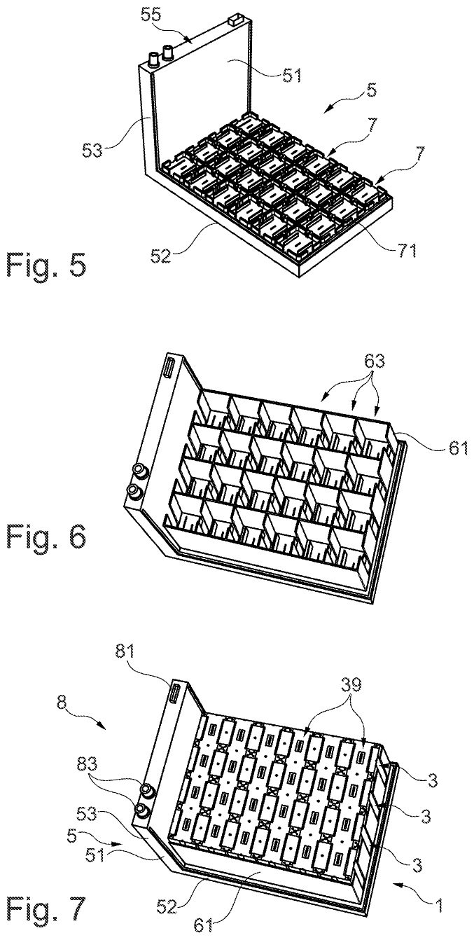

FIG. 5 shows the assembly 5 according to FIG. 1 without storage cell modules. FIG. 6 shows an assembly 5 which substantially corresponds to that according to FIG. 5, but which is additionally equipped with a vertical support structure 61. The support structure 61 forms a plurality of receptacles 63 for a corresponding number of storage cell modules 3 which are depicted in FIG. 7 in their insertion position. The flank sides of the storage cell modules 3 can be in planar touch contact with the support structure 61 in the insertion position. The base housing 51 can be arranged vertically below the storage cell modules in order to serve as a support for the storage cell modules.

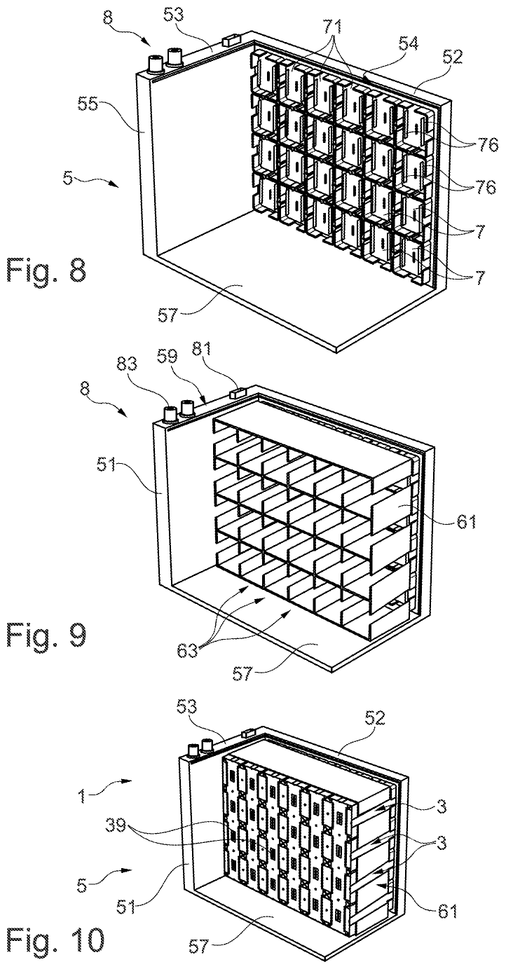

FIGS. 8 to 10 show another assembly 5 in which the interface 8 is aligned transversely to the directions of insertion of storage cell modules. The assembly 5 comprises a base housing 51 with a substantially L-shaped shape, wherein the connection plate 71 is arranged on a first leg 52 on the inner side 54. The second leg 53 extends in parallel to the direction of insertion of the storage cell modules.

The interface 8 is arranged in an upper lateral side 59 of the base housing 51. A support plate 57 is arranged on the opposite lower lateral side 58 of the base housing. The support plate 57 can form a stand for the horizontal L-shaped shape of the base housing 51. The support plate 57 an integral component of the base housing 51 or be connected thereto. The support plate extends in parallel to the direction of insertion. The plurality of storage cell modules 3 can be inserted or removed in their direction of insertion unhindered by the base housing 51. Neither the first leg 52 nor the second leg 53 and likewise not the support plate 57 stand in the way of the insertion or removal. In the embodiment illustrated in FIGS. 8 to 10, the base housing 51, in interaction with the support structure 61, can realize a shelf-like construction for supporting the plurality of storage cell modules 3.

It is clear that the exemplary embodiments according to the present disclosure 1 and the components thereof described with reference to the appended figures are purely exemplary and various other spatial configurations are conceivable.

The features of the present disclosure disclosed in the above description, the claims and the drawings can be essential both individually and in any desired combination for the realization of the present disclosure in its various embodiments.

The various embodiments described above can be combined to provide further embodiments. Patents referred to in this specification and/or listed in the Application Data Sheet are incorporated herein by reference, in their entirety. Aspects of the embodiments can be modified, if necessary to employ concepts of the various patents to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A modular battery system, comprising:
a plurality of electrical storage cell modules, each of the storage cell modules having a cell housing and an adapter connection arranged on a base side of the cell housing, and
an assembly having a base housing, containing:
a battery management system arranged in the base housing, arranged and adapted for monitoring and controlling charging and discharging of the plurality of electrical storage cell modules,
a plurality of adapter connections sites for reversibly receiving the adapter connections, wherein the adapter connections sites are form-fitted to the adapter connections and wherein the adapter connections sites and adapter connections have mutually corresponding electrical contacts,
at least one interface arranged on the base housing for electrically connecting the assembly to a consumer and/or supply system, and
power electronics arranged in the base housing for transmitting electrical energy between the at least one interface and the storage cell modules,
wherein the base housing has at least one opening for removing and/or inserting the plurality of storage cell modules opposite the adapter connections sites.

2. The modular battery system according to claim 1, wherein the base housing has a connection surface on at least one or exactly one outer side, on which the plurality of adapter connections sites is arranged.

3. The modular battery system according to claim 2, wherein the connection surface and the adapter connections sites have mutually corresponding heat transfer means arranged and adapted for dissipating thermal energy from the storage cell modules to the assembly and/or for introducing thermal energy from the assembly into the storage cell modules.

4. The modular battery system according to claim 2, wherein the base housing has an L-shaped basic shape, wherein the connection surface extends on an inner side, and/or wherein the at least one interface is arranged on a leg end.

5. The modular battery system according to claim 1, wherein the power electronics are arranged and adapted to connect the electrical contacts of the adapter connections sites to one another such that the storage cell modules received by the adapter connections sites form a battery.

6. The modular battery system according to claim 1, wherein the adapter connections sites have at least one electrical main connector.

7. The modular battery system according to claim 1, wherein the adapter connections sites have at least one mechanical and/or electronic reverse polarity protection which corresponds to a reverse polarity protection of at least one adapter connection of the electrical storage cell or of the storage module.

8. The modular battery system according to claim 1, wherein the adapter connections sites have a contact protection, arranged and adapted to ensure a correct connection of the electrical contacts.

9. The modular battery system according to claim 1, further comprising:
at least one telemetry unit, communication device, and/or power distribution device.

10. The modular battery system according to claim 1, wherein the storage cell module comprises a plurality of electrical storage cells arranged within the cell housing, wherein the storage cells of the storage cell module are connected in series and/or in parallel to a battery module, or wherein a single storage cell is accommodated in the cell housing of the storage cell module.

11. The modular battery system according to claim 1, wherein the plurality of electrical storage cell modules is free of individual measuring, monitoring and/or protective electronics.

12. The modular battery system according to claim 1, wherein the plurality of electrical storage cell modules is free of individual power electronics.

13. The modular battery system according to claim 1, further comprising at least one insulation monitoring unit.

14. The modular battery system according to claim 1, wherein the battery management system is adapted and arranged to monitor the state of charge, the state of health and the functional state of the plurality of electrical storage cell modules.

15. The modular battery system according to claim 1, wherein the assembly has a support structure which comprises receptacles for the plurality of storage cell modules.

16. The modular battery system according to claim 1, wherein the electrical storage cell modules are based on lithium-ion or solid-state battery technology.

17. The modular battery system according to claim 1, wherein the adapter connections sites and the respectively corresponding adapter connections are reversibly releasably connected or connectable to one another via a latching connection.

18. The modular battery system according to claim 1, further comprising at least one heat exchanger.

19. The modular battery system according to claim 1, wherein the assembly comprises at least one cooling aggregate and/or heating aggregate.

20. The modular battery system according to claim 1, wherein the cell housing comprises or constitutes a plastic housing.

21. The modular battery system according to claim 1, wherein the electrical storage cell modules are identically shaped,

22. The modular battery system according to claim 1, wherein the battery management system comprises measuring, monitoring, and/or protective electronics.

23. The modular battery system according to claim 6, wherein the adapter connections sites are identically shaped.

24. The modular battery system according to claim 9, wherein the at least one telemetry unit, communication device and/or power distribution device is arranged within the base housing.

25. The modular battery system according to claim 10, wherein the plurality of electrical storage cells is arranged stacked.

26. The modular battery system according to claim 1, wherein the plurality of electrical storage cell modules is free of an individual battery management system.

27. The modular battery system according to claim 15, wherein the receptacles are shaped to be complementary in shape to the cell housings and/or wherein the receptacles form the removal opening.

28. The modular battery system according to claim 19, wherein the cooling aggregate and/or heating aggregate is accommodated in the base housing.
